(19) United States
(12) Patent Application Publication
(10) Pub. No.: US 2025/0135401 A1
(43) Pub. Date: May 1, 2025

(54) Gas Circulation Apparatus for Degradation of Sulfur Hexafluoride Gas, and Gas Scrubbing Mechanism

(71) Applicant: Guizhou Power Grid Co., Ltd., Guiyang (CN)

(72) Inventors: Ying ZHANG, Guiyang (CN); Mingwei WANG, Guiyang (CN); Zhe LIU, Guiyang (CN)

(21) Appl. No.: 19/006,809

(22) Filed: Dec. 31, 2024

Related U.S. Application Data
(63) Continuation of application No. PCT/CN2024/105456, filed on Jul. 15, 2024.

(30) Foreign Application Priority Data
Aug. 18, 2023 (CN) 2023110448367

(51) Int. Cl. B01D 53/78; B01D 53/48

(52) U.S. Cl. CPC B01D 53/78; B01D 53/485; B01D 2257/30

(57) ABSTRACT

The present invention relates to the technical field of gas treatment, and in particular to a gas circulation apparatus for degradation of a sulfur hexafluoride gas, and a gas scrubbing mechanism, the gas circulation apparatus including: gas cylinders, gas circuits, relief valves, electromagnetic flowmeters, temperature sensors, flow sensors and electromagnetic valves, a discharge reactor, a gas scrubbing mechanism, a buffer gas bag, and a buffer gas chamber, According to the device, the tail gas can be pretreated, temporarily stored and recycled in the degradation process of SF6.

### CROSS-REFERENCE TO RELATED APPLICATIONS

The present application claims priority to Chinese Patent Application No. 2023110448367, filed on Aug. 18, 2023, the entire disclosure of which is incorporated herein by reference.

### TECHNICAL FIELD

The present invention relates to the technical field of gas treatment, and in particular to a gas circulation apparatus for degradation of a sulfur hexafluoride gas, and a gas scrubbing mechanism.

### BACKGROUND

Sulfur hexafluoride (SF6) is a synthetic gas, with a central sulfur atom stably connected to surrounding six fluorine atoms through covalent bonds, showing an octahedral configuration. The SF6 gas is colorless, odorless, nontoxic, nonflammable and slightly soluble in water, and has very stable chemical property and strong electron affinity. A self-recovery process can occur after bond breakage, so excellent insulation property and arc-extinguishing property are achieved. SF6 serves as an excellent gas insulating material to be widely applied to electric power industry, and also serves as a protective gas to be applied in the fields of semiconductor processing and ore smelting. Although SF6 has numerous excellent properties, the efficient absorption of infrared radiation at the waveband of 915-960 cm-1 will lead to serious greenhouse effect. SF6 is listed as one of six restricted gases in Kyoto Protocol, and the global warming potential (GWP) is 23500 times that of CO2, far exceeding other greenhouse gases. SF6 can exist stably in the atmosphere for 3200 years, and be decomposed slowly only under ultraviolet irradiation. Therefore, the massive emission of SF6 waste gas poses a serious threat to the atmospheric environment. For the discharge treatment process of SF6, the mainstream method is to adopt dielectric barrier discharge, microwave discharge and other forms to form a plasma region in a specified rector and decompose the SF6 gas. In “Experimental and Simulation Study on Degradation of SF6 by Dielectric Barrier Discharge Plasma” published in Proceedings of the CSEE by Zhang Xiaoxing and others of Wuhan University in 2017, DBD discharge of the SF6 waste gas is achieved by a quartz glass reactor, the treatment process of SF6 requires dilution, the diluent gas is usually nitrogen and air, and finally, the degradation effect of more than 90% can be achieved.

During the treatment of SF6, it is necessary to use a gas scrubbing pool to scrub a SF6 mixed gas. An alkali liquor gas scrubbing pool is usually used, and it is necessary to change alkali liquor in the pool after long-time gas scrubbing, but it is necessary to suspend gas scrubbing when the gas scrubbing pool in the prior art is changed, thereby affecting the processing efficiency.

Furthermore, the SF6 gas is degraded in a static environment, and products are mainly acidic toxic gases, so the emission is limited. Other scholars also need to dilute the SF6 gas when studying the electrolytic process of the SF6 waste gas. The SF6 gas with an excessive concentration will inhibit the discharge process and weaken the treatment effect, and a large number of gases are required to be consumed in the dilution process, resulting in the waste of gas.

### SUMMARY

An objective of the present part is to outline some aspects of the embodiments of the present invention and to briefly describe some preferred embodiments. Some simplifications or omissions may be made in the present part as well as the abstract of the specification and the title of invention of the present application, so as not to obscure the objective of the present part as well as the abstract of the specification and the title of invention; however, such simplifications or omissions cannot be used for limiting the scope of the present invention.

In view of the above problem that a large number of gases are consumed in the dilution process, the present invention is provided.

Therefore, an objective of the present invention is to provide a gas circulation apparatus for degradation of a sulfur hexafluoride gas.

To solve the above technical problem, the present invention provides the following technical solution: a gas circulation apparatus for degradation of a sulfur hexafluoride gas includes: gas cylinders, gas circuits arranged on the gas cylinders, and relief valves, electromagnetic flowmeters, temperature sensors, flow sensors and electromagnetic valves arranged on the gas circuits sequentially; a discharge reactor, an input end of the discharge reactor communicating with output ends of the electromagnetic valves; a gas scrubbing mechanism, an input end of the gas scrubbing mechanism communicating with an output end of the discharge reactor; a buffer gas bag, an input end of the buffer gas bag communicating with an output end of the gas scrubbing mechanism; and a buffer gas chamber, an input end of the buffer gas chamber communicating with an output end of the buffer gas bag, and an output end of the buffer gas chamber communicating with the gas circuits.

As a preferred solution of the gas circulation apparatus for degradation of the sulfur hexafluoride gas according to the present invention, two gas cylinders are provided, the content of one gas cylinder is the sulfur hexafluoride gas, and the content of the other gas cylinder is an external gas.

As a preferred solution of the gas circulation apparatus for degradation of the sulfur hexafluoride gas according to the present invention, the gas cylinders are connected to the relief valves, an ultrasonic atomizer is arranged between the two gas circuits, and the output end of the buffer gas chamber is communicated between one relief valve and one electromagnetic flowmeter.

The gas circulation apparatus for degradation of the sulfur hexafluoride gas according to the present invention has the beneficial effects that: the gas circulation apparatus can be connected to the gas cylinders of Ar and SF6 gas to perform input into the gas circuits according to a specified pressure, humidity and flow rate to dilute the SF6 gas. The diluted mixed gas is scrubbed by the gas scrubbing mechanism after being degraded in the discharge reactor, and gas that is insoluble and slightly soluble in alkali liquor in the degraded gas can be adsorbed after the gas passes through a solid-state adsorbent. The residual tail gas can be directly discharged or stored in the buffer gas chamber. The gas inside the buffer gas chamber can be pumped into the gas circuits of the gas cylinders through a minitype compressor, and this part of gas is mainly diluted gas and can be reused. Meanwhile, the gas inside the buffer gas chamber can be controlled and discharged by the electromagnetic valves. When the gas in the buffer gas chamber is not enough to implement circulation, the gas in the buffer gas bag can be pumped by the minitype compressor to increase the pressure of the buffer gas chamber, thereby providing an initial gas flow of a circulation gas circuit. According to the device, the tail gas can be pretreated, temporarily stored and recycled in the degradation process of SF6.

In actual use, it is also necessary to stop working to change liquid in the gas scrubbing pool.

To solve the above technical problem, the present invention further provides the following technical solution: a gas scrubbing mechanism includes: a bearing part, including a bearing assembly and a gas supply assembly arranged on the bearing assembly; inserting parts, including inserting assemblies arranged on the bearing assembly and closed assemblies arranged on the inserting assemblies; fixing parts, including fixing assemblies arranged on the inserting assemblies and locking assemblies arranged on the gas supply assembly; and cleaning parts, including water-collecting assemblies arranged on the bearing assembly, transmission assemblies arranged on the bearing assembly and cleaning assemblies arranged on the bearing assembly, where the bearing assembly includes a box body, an inserting cavity arranged on the box body, a limiting groove formed in the box body and supporting legs arranged on the box body.

As a preferred solution of the gas scrubbing mechanism according to the present invention, the gas supply assembly includes a distribution gas chamber arranged on the box body, a gas inlet pipe arranged on the distribution gas chamber and distribution gas pipes arranged on the distribution gas chamber, where several distribution gas pipes are provided, and the distribution gas pipes communicate with the inserting cavity.

As a preferred solution of the gas scrubbing mechanism according to the present invention, the inserting assemblies include case bodies arranged on the inserting cavity, communicating pipes arranged on the case bodies and exhaust pipes arranged on the case bodies; the closed assemblies include sealing rings arranged on the communicating pipes, connecting springs arranged on the case bodies, sealing pieces arranged on the connecting springs and ejection pieces arranged on the distribution gas pipes; and the exhaust pipes are arranged at the top ends of the case bodies, the communicating pipes are matched with the distribution gas pipes, the sealing pieces are matched with the communicating pipes, and the sealing pieces are in contact with the ejection pieces.

As a preferred solution of the gas scrubbing mechanism according to the present invention, the fixing assemblies include bosses arranged on the communicating pipes, fixed blocks arranged on the communicating pipes and movable blocks arranged on the communicating pipes; the locking assemblies include connecting pieces arranged on the box body and jacking pieces arranged on the box body; the connecting pieces include connecting cylinders arranged on the box body, partition plates arranged on the connecting cylinders, sliding grooves formed in the partition plates and wedge blocks arranged on the sliding grooves; and the jacking pieces include jacking springs arranged on the box body and jacking plates arranged on the jacking spring.

As a preferred solution of the gas scrubbing mechanism according to the present invention, the water-collecting assemblies include water-collecting pieces arranged on the box body and water-collecting tanks arranged on the box body; the transmission assemblies include accommodating grooves formed in the case bodies, driving teeth arranged in the accommodating grooves, transmission gears arranged on the box body, movable racks arranged on the box body and limiting tracks arranged on the box body; and the driving teeth, the transmission gears and the movable racks are engaged mutually, and the sizes of the movable racks are matched with the sizes of the water-collecting pieces.

As a preferred solution of the gas scrubbing mechanism according to the present invention, the cleaning assemblies include moving grooves formed in the water-collecting pieces and cleaning pieces arranged on the moving grooves; and the water-collecting pieces include connecting plates arranged on the box body and ramps arranged on the connecting plates, the moving grooves are formed in surfaces of the connecting plates, the cleaning piece are in sliding connection with the moving grooves, and the cleaning pieces are matched with the ramps.

As a preferred solution of the gas scrubbing mechanism according to the present invention, several inserting parts, fixing parts and cleaning parts are provided, the cleaning parts are arranged on a lower surface of the box body, and the water-collecting tanks are adapted to the positions of the joints of the distribution gas pipes and the communicating pipes.

The gas scrubbing mechanism according to the present invention has the following beneficial effects: according to the bearing assembly and the inserting assemblies, the gas supply assembly is mounted on the bearing assembly, and the gas supply assembly communicates with an external gas source; during use, the inserting assemblies are inserted into the inserting cavity of the box body, at this time, the case bodies communicate with and are fixed with the distribution gas pipes, the case bodies are filled with gas scrubbing liquid, gases to be scrubbed in the distribution gas pipes enter the case bodies for scrubbing and are distributed from the exhaust pipes after scrubbing; when the liquid in the case bodies are used for a long time and required to be changed, the corresponding distribution gas pipes can be directly closed and the inserting assemblies are pulled out, so that the case bodies are taken out; and at this time, other inserting assemblies maintain normal gas scrubbing, and the liquid can be changed without stopping work and is simple and convenient to change, thereby facilitating use.

### BRIEF DESCRIPTION OF DRAWINGS

To more clearly illustrate the technical solutions of the embodiments of the present invention, the following is a brief introduction to the drawings required for the description of the embodiments. Obviously, the drawings described below are only some embodiments of the present invention. For those of ordinary skill in the art, other drawings can be obtained based on these drawings without creative labor. In the drawings:

FIG. 1 is an overall schematic diagram of a gas circulation apparatus for degradation of a sulfur hexafluoride gas;

FIG. 2 is an overall schematic diagram of a gas scrubbing mechanism;

FIG. 3 is a schematic diagram of an overall structure of a gas scrubbing mechanism from another perspective;

FIG. 4 is a schematic diagram of a sectional structure of a gas scrubbing mechanism;

FIG. 5 is a schematic diagram of a sectional structure of a cleaning assembly of a gas scrubbing mechanism;

FIG. 6 shows a sectional schematic diagram of a gas scrubbing mechanism;

FIG. 7 shows a sectional schematic diagram of a gas scrubbing mechanism from another perspective;

FIG. 8 is a schematic structural diagram of a sealing piece of a gas scrubbing mechanism;

FIG. 9 is a schematic structural diagram of a locking assembly of a gas scrubbing mechanism; and

FIG. 10 is a schematic structural diagram of a communicating pipe of a gas scrubbing mechanism.

### DETAILED DESCRIPTION OF THE EMBODIMENTS

To make the described objectives, features and advantages of the present invention more obvious and more understandable, the specific embodiments of the present invention are described in detail below in conjunction with the accompanying drawings.

A number of specific details are set forth in the description below to provide a thorough understanding for the present invention, however, the present invention may also be implemented in other manners different from those described herein, and those skilled in the art may make similar generalization without departing from the essence of the present invention; therefore, the present invention is not limited by the specific embodiments disclosed below.

Secondly, “one embodiment” or “embodiment” referred to herein refers to a specific feature, structure, or characteristic that may be included in at least one implementation manner of the present invention. The “in one embodiment” appearing in different parts of the present specification does not necessarily refer to the same embodiment, nor a separate or selective embodiment that is mutually exclusive to other embodiments.

Thirdly, the present invention is described in detail in conjunction with illustrations. When the embodiments of the present invention are described in detail, for ease of description, sectional views of the device structures are partially enlarged without being drawn to scale. The illustrations are merely exemplary and should not limit the protection scope of the present invention. Furthermore, it is important to consider the three-dimensional spatial dimensions of length, width, and depth in actual production.

### Embodiment 1

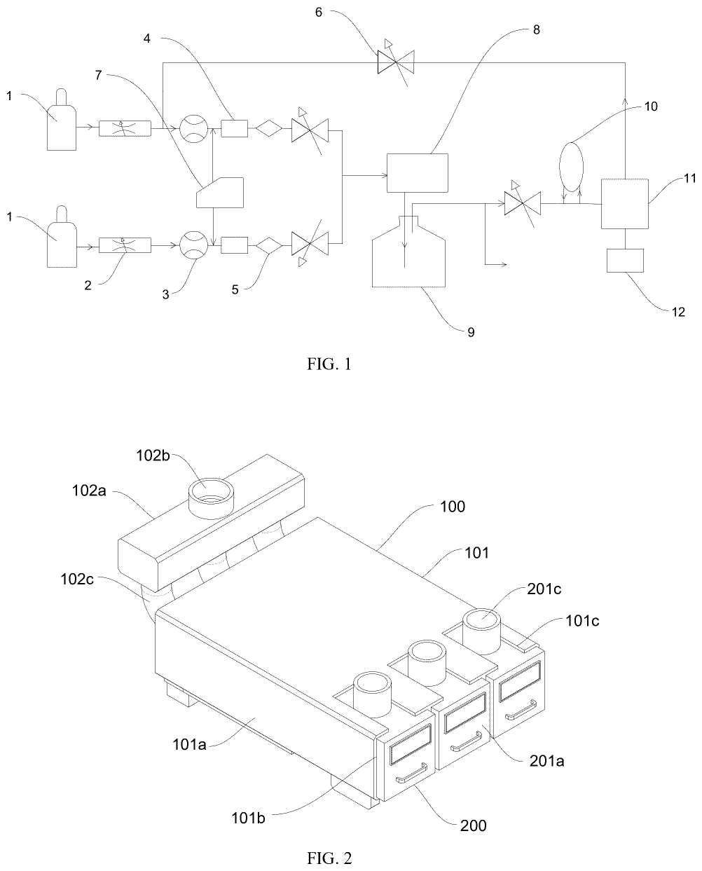

Referring to FIG. 1, a schematic diagram of an overall structure of a gas circulation apparatus for degradation of a sulfur hexafluoride gas is provided. A gas circulation apparatus for degradation of a sulfur hexafluoride gas includes: gas cylinders 1, gas circuits arranged on the gas cylinders 1, and relief valves 2, electromagnetic flowmeters 3, temperature sensors 4, flow sensors 5 and electromagnetic valves 6 arranged on the gas circuits sequentially; a discharge reactor 8, an input end of the discharge reactor 8 communicating with output ends of the electromagnetic valves 6; a gas scrubbing mechanism 9, an input end of the gas scrubbing mechanism 9 communicating with an output end of the discharge reactor 8; a buffer gas bag 10, an input end of the buffer gas bag 10 communicating with an output end of the gas scrubbing mechanism 9; and a buffer gas chamber 11, an input end of the buffer gas chamber 11 communicating with an output end of the buffer gas bag 10, and an output end of the buffer gas chamber 11 communicating with the gas circuits,
specifically, for example, the gas cylinders 1, the electromagnetic flowmeters 3, the electromagnetic valves 6, an ultrasonic atomizer 7, a humidity sensor, the flow sensors 5, the discharge reactor 8, a gas scrubbing pool, the buffer gas chamber 11 and the like. The gas cylinders 1 are connected to the gas circuits of the electromagnetic valves 6, the ultrasonic atomizer 7, the humidity sensor, the flow sensors 5 and the discharge reactor 8 in series, a gas outlet of the discharge reactor 8 is connected to the gas scrubbing pool, an outlet gas circuit of the gas scrubbing pool is partially connected to the buffer gas chamber 11, and an outlet gas circuit of the buffer gas chamber 11 is connected to one gas circuit at the joint of the gas cylinders 1.

The gas cylinders 1 includes two gas circuits, each of the gas circuits sequentially includes one relief valve 2, one electromagnetic flowmeter 3, one temperature sensor 4, one flow sensor 5 and one electromagnetic valve 6, the gas cylinders 1 are connected to the relief valves 2, the depressurized gas enters a gas circuit channel, the ultrasonic atomizer 7 generates water mist to be mixed with the gas, and then connects the connected humidity sensor, and finally, the two gas circuits converge into one circuit to be connected to a gas inlet of the discharge reactor 8.

Further, two gas cylinders 1 are provided, the content of one gas cylinder 1 is the sulfur hexafluoride gas, and the content of the other gas cylinder 1 is an external gas.

Further, the gas cylinders 1 are connected to the relief valves 2, an ultrasonic atomizer 7 is further arranged between the two gas circuits, and an output end of the buffer gas chamber 11 is communicated between the relief valves 2 and the electromagnetic flowmeters 3.

The buffer gas chamber 11 can temporarily store gas, a gas outlet is connected to one gas circuit of the gas cylinders 1, a pressure gauge 12 is connected below the buffer gas chamber 11 to monitor the gas pressure in real time, and the dilution ratio of SF6 can be accurately controlled by the relief valves 2 and the electromagnetic flowmeters 3 on the two circuits. Meanwhile, in the gas circulation process, the relief valves 2 on the two circuits can be adjusted according to the gas pressure condition of the buffer gas chamber 11, and the adding amount of SF6 can be adjusted and controlled in real time. There is no special designation for the discharge reactor 8, which can decompose SF6 in the device and provide a place for gas circulation. The apparatus should at least include gas inlet and outlet for connecting the two gas circuits, thereby ensuring the internal gas flow can be circulated. The gas scrubbing mechanism 9 is full of a calcium hydroxide saturated solution for gas scrubbing. The buffer gas bag 10 is provided with a buffer inner pipe, the electromagnetic valve 6 apparatus is arranged at the inlet and outlet of the buffer gas bag 10, and a minitype compressor is arranged between the buffer gas bag 10 and the buffer inner pipe, so that the gas in the buffer gas chamber 11 can be compressed and the pressurization effect can be achieved. A tail end of the buffer gas chamber 11 is connected to the electromagnetic valve 6 and is connected to one gas circuit of the gas cylinder 1. The buffer gas chamber 11 is required to be connected to one pressure gauge 12 to monitor the gas pressure in real time.

Operation process: the gas cylinders 1 include two gas circuits, and each of the gas circuits is sequentially connected to devices such as the relief valve 2, the electromagnetic flowmeter 3, the temperature sensor 4, the flow sensor 5 and the electromagnetic valve 6. During use, the gas cylinders 1 of the diluted gas and the SF6 gas are connected first and then are depressurized by the relief valves 2 to respectively enter two gas circuits under the specified pressure. The electromagnetic flowmeters 3 monitor the flow velocities of the Ar gas and the SF6 gas, the two gases are mixed according to an appropriate ratio, the ultrasonic atomizer 7 generates water mist to be mixed with the gas, the connected humidity sensor accurately detects the humidity of the gas, the flow sensors 5 monitor the flow rate of the gas in real time, thereby accurately diluting SF6; and the electromagnetic valves 6 control the on and off process of the Ar gas circuit and the SF6 gas circuit.

After SF6 is diluted and mixed, the mixed gas is controlled by the two electromagnetic valves 6 to enter the discharge reactor 8 according to a specified flow velocity, a related degradation process of SF6 occurs in the reactor, the finally degraded tail gas enters an alkali liquor gas scrubbing pool through gas circuit connection for gas scrubbing, and a saturated calcium hydroxide solution is in the gas scrubbing pool and can react with the degraded gas of SF6 to implement the scrubbing process. The finally scrubbed tail gas includes the Ar gas and a small amount of SF6 gas, and may also include a small amount of SF6 degraded gas that is scrubbed incompletely.

The washed gas can be discharged or collected directly through the electromagnetic valve 6 to enter the buffer gas bag 10. The buffer gas bag 10 is generally in a full state and can resist a pressure not less than 2 atmospheric pressures. The gas in the buffer gas bag can be pumped into the buffer gas chamber 11 within a short time, and a positive pressure is formed in the buffer gas chamber 11 to provide an initial pressure for gas circulation. One gas outlet of the buffer gas chamber 11 is connected to the electromagnetic valve 6, and is controlled by the electromagnetic valve 6 to be connected to the electromagnetic flowmeter 3 at the joint of the gas cylinders 1 so as to form a circulating closed gas circuit. Meanwhile, the buffer gas chamber 11 is further provided with a pressure gauge 12, so that the pressure condition of the buffer gas chamber 11 can be monitored in real time. In the degradation process, gas can be taken through the electromagnetic valves 6, and the degradation condition of the SF6 gas can be monitored by means of other detection devices, so that the input ratio of SF6 can be adjusted at any time.

### Embodiment 2

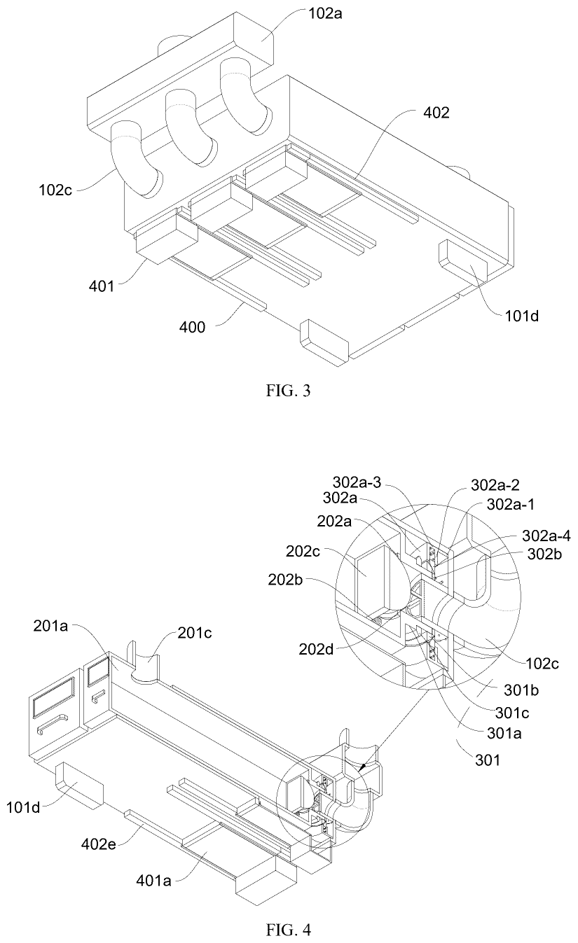

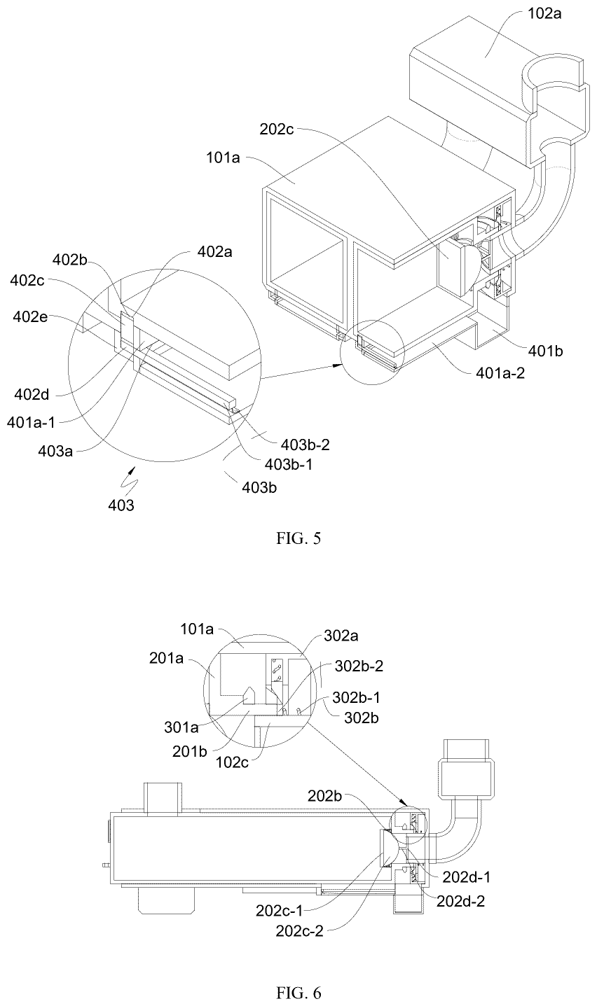

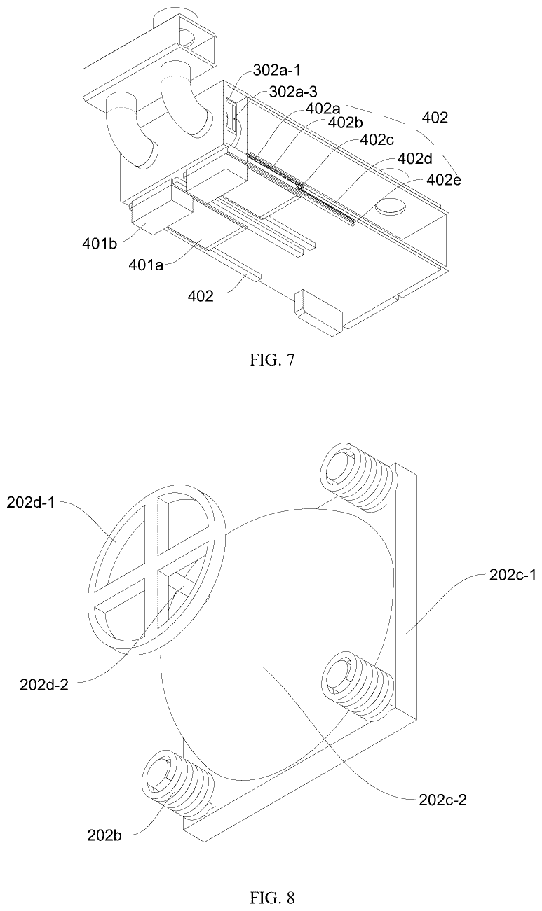

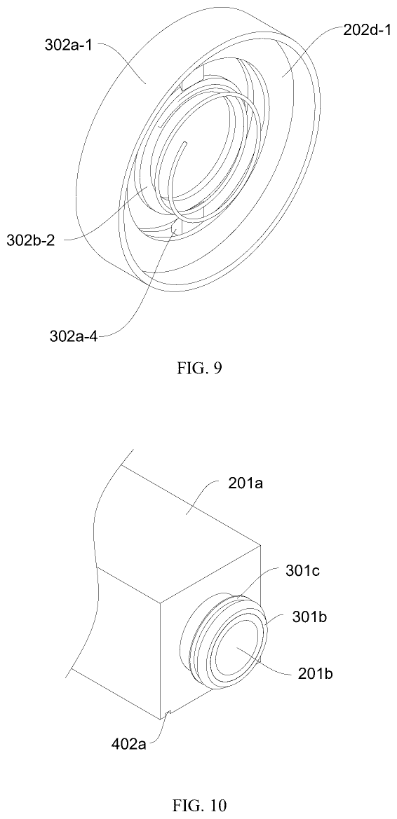

Referring to FIG. 2 to FIG. 10, a gas scrubbing mechanism includes: a bearing part 100, including a bearing assembly 101 and a gas supply assembly 102 arranged on the bearing assembly 101; inserting parts 200, including inserting assemblies 201 arranged on the bearing assembly 101 and closed assemblies 202 arranged on the inserting assemblies 201; fixing parts 300, including fixing assemblies 301 arranged on the inserting assemblies 201 and locking assemblies 302 arranged on the gas supply assembly 102; and cleaning parts 400, including water-collecting assemblies 401 arranged on the bearing assembly 101, transmission assemblies 402 arranged on the bearing assembly 101 and cleaning assemblies 403 arranged on the bearing assembly 101, where the bearing assembly 101 includes a box body 101a, an inserting cavity 101b arranged on the box body 101a, a limiting groove 101c formed in the box body 101a and supporting legs 101d arranged on the box body 101a.

Specifically, the gas supply assembly 102 is fixed on the bearing assembly 101, the gas supply assembly and the bearing assembly are fixedly connected, the gas supply assembly 102 communicates with an external gas source, gases required to be scrubbed are distributed, the inserting parts 200 are inserted into the bearing assembly 101, a plurality of inserting parts 200 are provided, the gas supply assembly 102 supplies gas to each of the inserting parts 200 simultaneously, and waste water dropped after the inserting parts 200 are separated can be collected by the water-collecting assemblies 401 and are cleaned and stored by the cleaning assemblies 403.

Further, the gas supply assembly 102 includes a distribution gas chamber 102a arranged on the box body 101a, a gas inlet pipe 102b arranged on the distribution gas chamber 102a and distribution gas pipes 102c arranged on the distribution gas chamber 102a, where several distribution gas pipes 102c are provided, the distribution gas pipes 102c communicate with the inserting cavity 101b, the external gas source enters the distribution gas chamber 102a through the gas inlet pipe 102b first and then is fed into each of the distribution gas pipes 102c through the distribution gas chamber 102a, and an output end of each of the distribution gas pipes 102c is inserted into the inserting cavity 101b of the box body 101a and is fixed.

Further, the inserting assemblies 201 include case bodies 201a arranged at the inserting cavity 101b, communicating pipes 201b arranged on the case bodies 201a and exhaust pipes 201c arranged on the case bodies 201a; the closed assemblies 202 include sealing rings 202a arranged on the communicating pipes 201b, connecting springs 202b arranged on the case bodies 201a, sealing pieces 202c arranged on the connecting springs 202b and ejection pieces 202d arranged on the distribution gas pipes 102c; and the exhaust pipes 201c are arranged at the top ends of the case bodies 201a, the communicating pipes 201b are matched with the distribution gas pipes 102c, the sealing pieces 202c are matched with the communicating pipes 201b, each of the sealing pieces 202c includes a square mounting plate 202c-1 and a sealing semisphere 202c-2 arranged on the mounting plate 202c-1, the sealing pieces 202c are in contact with the ejection pieces 202d, the case bodies 201a are matched with the size of the inserting cavity 101b and are in sliding fit with the inserting cavity, the communicating pipes 201b are arranged at one end of each of the case bodies 201a close to the distribution gas pipes 102c, the communicating pipes 201b are matched with the distribution gas pipes 102c, the exhaust pipes 201c are arranged on upper surfaces of the case bodies 201a, and the exhaust pipes 201c are matched with the size of the limiting groove 101c, when the case bodies 201a are inserted into the box body 101a. The communicating pipes 201b are connected and fixed with the distribution gas pipes 102c, and the exhaust pipes 201c move inward through the limiting groove 101c.

Further, the fixing assemblies 301 include bosses 301a arranged on the communicating pipes 201b, fixed blocks 301b arranged on the communicating pipes 201b and movable blocks 301c arranged on the communicating pipes 201b; the fixed blocks 301b are of circular truncated cone-shaped structures, and two ends of the movable blocks 301c are provided with inclined surfaces; the locking assemblies 302 include connecting pieces 302a arranged on the box body 101a and jacking pieces 302b arranged on the box body 101a; the connecting pieces 302a include connecting cylinders 302a-1 arranged on the box body 101a, partition plates 302a-2 arranged on the connecting cylinders 302a-1, sliding grooves 302a-3 formed in the partition plates 302a-2 and wedge blocks 302a-4 arranged on the sliding grooves 302a-3; the jacking pieces 302b include jacking springs 302b-1 arranged on the box body 101a and jacking plates 302b-2 arranged on the jacking spring 302b-1; and the bosses 301a are arranged at outer rings of the communicating pipes 201b, the fixed blocks 301b are arranged at the top ends of the communicating pipes 201b, the movable blocks 301c are arranged between the bosses 301a and the fixed blocks 301b, the movable blocks 301c are movably connected to the communicating pipes 201b, one surface of each of the jacking pieces 302b is attached to the communicating pipes 201b, the communicating pipes 201b keep pressing the jacking pieces 302b after mounting, one end of each of the connecting cylinders 302a-1 is fixedly connected to the box body 101a and sleeved outside the distribution gas pipes 102c, the other end of each of the connecting cylinders 302a-1 is provided with an annular plate that is the same as the partition plates 302a-2, the sliding grooves 302a-3 are formed between the annular plate and the partition plates 302a-2, the wedge blocks 302a-4 moves in the sliding grooves 302a-3, springs are arranged at the bottoms of the wedge blocks 302a-4 to be connected to the connecting cylinders 302a-1, part of the wedge blocks are still located in the sliding grooves 302a-3 when the wedge blocks 302a-4 are ejected, and inclined surfaces of the wedge blocks 302a-4 are matched with the fixed blocks 301b and the movable blocks 301c.

Other structures are identical to those of Embodiment 1.

Operation process: during use, each of the inserting parts 200 is inserted into the inserting cavity 101b of the box body 101a, so that the communicating pipes 201b on the case bodies 201a communicate with the distribution gas pipes 102c on the box body 101a; the ejection pieces 202d in the distribution gas pipes 102c eject the sealing pieces 202c inward, so that the communicating pipes 201b are opened; the fixed assemblies 301 outside the communicating pipes 201b and the locking assemblies 302 in the box body 101a are connected mutually; the wedge blocks 302a-4 of the locking assemblies 302 are ejected by the fixed blocks 301b in the inserting process and then are clamped between the movable blocks 301c and the fixed blocks 301b; the thickness of the wedge blocks 302a-4 is the same as the distance between the movable blocks 301c and the fixed blocks 301b; at this time, the case bodies 201a can be fixed, and the jacking pieces 302b keep ejecting the communicating pipes 201b outward, thereby preventing the case bodies 201a from shaking; if it is necessary to disassemble the case bodies 201a, the wedge blocks can be continuously inserted into the case bodies 201a, and the wedge blocks 302a-4 can be pressed into the sliding grooves 302a-3 again and are clamped in the movable blocks 301c; and at this time, the case bodies 201a are drawn out, and the wedge blocks 302a-4 drives the movable blocks 301c to the fixed blocks 301b, so that the wedge blocks 302a-4 can be separated from the communicating pipes 201b, and the case bodies 201a can be removed.

### Embodiment 3

Referring to FIG. 4 to FIG. 10, this embodiment is different from the above embodiments in that: the water-collecting assemblies 401 include water-collecting pieces 401a arranged on the box body 101a and water-collecting tanks 401b arranged on the box body 101a; the transmission assemblies 402 include accommodating grooves 402a formed in the case bodies 201a, driving teeth 402b arranged in the accommodating grooves 402a, transmission gears 402c arranged on the box body 101a, movable racks 402d arranged on the box body 101a and limiting tracks 402e arranged on the box body 101a; and the driving teeth 402b, the transmission gears 402c and the movable racks 402d are engaged mutually, and the sizes of the movable racks 402d are matched with the sizes of the water-collecting pieces 401a.

Specifically, a through groove is formed at the bottom of the box body 101a, the water-collecting assemblies 401 are arranged below the through groove, the water-collecting tanks 401b are located below the joint of the communicating pipes 201b and the distribution gas pipes 102c and used to collect waste water leaked after the case bodies 201a are separated, the accommodating grooves 402a are formed in two sides of the bottoms of the case bodies 201a, the limiting tracks 402c are arranged below the box body 101a, and after the case bodies 201a are inserted, the driving teeth 402b can drive the transmission gears 402c to rotate, the transmission gears 402c drive the movable racks 402d to move, the movable racks 402d moves in the limiting tracks 402e, and each of the limiting racks 402e is twice as long as each of the accommodating grooves 402a.

Further, the cleaning assemblies 403 include moving grooves 403a formed in the water-collecting pieces 401a and cleaning pieces 403b arranged on the moving grooves 403a; the water-collecting pieces 401a include connecting plates 401a-1 arranged on the box body 101a and ramps 401a-2 arranged on the connecting plates 401a-1, the moving grooves 403a are formed in surfaces of the connecting plates 401a-1, the cleaning piece 403b are in sliding connection with the moving grooves 403a, and the cleaning pieces 403b are matched with the ramps 401a-2; the connecting plates 401a-1 are arranged on two sides of the through groove at the bottom of the box body 101a, the moving grooves 403a are formed in the connecting plates 401a-1, the ramps 401a-2 are arranged at the bottoms of the connecting plates 401a-1, and the ramps 401a-2 are provided with slopes facing the water-collecting tanks 401b; each of the cleaning pieces 403b include a mounting rod 403b-1, two ends of the mounting rod 403b-1 are fixedly connected to the movable racks 402d, a scraping plate 403b-2 is arranged on a lower surface of the mounting rod 403b-1, and the scraping plate 403b-2 adopts a deformable material; when the movable racks 402d moves, the movable racks drive the mounting rod 403b-1 to move so as to drive the scraping plate 403b-2 to sweep the ramps 401a-2, so that waste water is scraped into the water-collecting tanks 401b; the movement of the movable racks 402d is opposite to the movement of the case bodies 201a, so when the case bodies 201a are drawn out, the scraping plate 403b-2 moves inward for sweeping; and when being inserted into the case bodies 201a, the scraping plate 403b-2 moves to one end away from the water-collecting tanks 401b.

Further, several inserting parts 200, fixing parts 300 and cleaning parts 400 are provided, the cleaning parts 400 are arranged on the lower surface of the box body 101a, the water-collecting tanks 401b are adapted to the joint of the distribution gas pipes 102c and the communicating pipes 201b, and when each of the case bodies 201a is inserted and drawn out, the cleaning pieces 403b will move for cleaning.

Other structures are identical to those of Embodiment 2.

Operation process: when the case bodies 201a are inserted, the driving teeth 402b at the bottoms of the case bodies 201a drive the transmission gears 402c to rotate so as to drive the racks to move along the limiting tracks 402e to an opposite direction, so that the cleaning pieces 403b are driven to one end away from the water-collecting tanks 401b; when the case bodies 201a are drawn out, the driving teeth 402b drive the racks to move toward the water-collecting tanks 401b again, so that the cleaning pieces 403b move toward the water-collecting tanks 401b, and the scraping plate 403b-2 can sweep the waste water on the ramps 401-2 at this time to scrape the waste water into the water-collecting tanks 401b for collection.

Importantly, it should be noted that the constructions and arrangements of the present application shown in a plurality of different exemplary implementation solutions are merely exemplary. Although only a few implementation solutions are described in detail in the contents disclosed herein, those having reference to the contents disclosed herein should readily understand that many modifications are possible (for example, variations in the sizes, dimensions, structures, shapes and proportions of various elements, parameter values (such as temperatures and pressures), installations and arrangements, use of materials, colors, orientations, etc.), without materially departing from the novel teachings and advantages of the subject described in the present application. For example, the elements shown as integrally formed may be constructed of a plurality of parts or elements, the positions of the elements may be inverted or varied in other manners, and the properties, quantities or positions of the discrete elements may be altered or varied. Therefore, all such modifications are intended to be included within the scope of the present invention. The order or sequence of any process or method steps may be changed or re-sequenced according to alternative embodiments. In the claims, any provision of “apparatus with function” is intended to cover the structure described herein for executing the function, and is not merely structurally equivalent but also equivalent in structure. Other substitutions, modifications, variations, and omissions may be made in the design, operation conditions, and arrangements of the exemplary implementation solutions without departing from the scope of the present invention. Therefore, the present invention is not limited to the specific implementation solutions but extends to a plurality of modifications still falling within the scope of the appended claims.

In addition, for a concise description of the exemplary implementation solutions, all features of actual embodiments (that is, those that are not related to the currently considered best mode for carrying out the present invention, or those that are not related to the practice of the present invention) may not be described.

It should be understood that in the development process of any practical implementation, such as in any engineering or design project, a large number of specific implementation decisions may be made. Such development efforts might be complex and time-consuming, but for ordinary technical personnel who benefit from this disclosed content, there is no need for excessive experimentation. The development efforts will be a routine task of design, manufacturing, and production.

It should be noted that the above embodiments are only intended to illustrate the technical solution of the present invention and not to limit it. Although the preferred embodiments have been described in detail, those skilled in the art should understand that modifications or equivalent substitutions may be made to the technical solution of the present invention without departing from its essence and scope, which are all within the scope of the claims of the present invention.

What is claimed is:

1. A gas circulation apparatus for degradation of a sulfur hexafluoride gas, comprising:
gas cylinders, gas circuits arranged on the gas cylinders, and relief valves, electromagnetic flowmeters, temperature sensors, flow sensors and electromagnetic valves arranged on the gas circuits sequentially;
a discharge reactor, an input end of the discharge reactor communicating with output ends of the electromagnetic valves;
a gas scrubbing mechanism, an input end of the gas scrubbing mechanism communicating with an output end of the discharge reactor;
a buffer gas bag, an input end of the buffer gas bag communicating with an output end of the gas scrubbing mechanism;
a buffer gas chamber, an input end of the buffer gas chamber communicating with an output end of the buffer gas bag, and an output end of the buffer gas chamber communicating with the gas circuits; and a pressure gauge arranged on the buffer gas chamber.

2. The gas circulation apparatus for degradation of a sulfur hexafluoride gas according to claim 1, wherein two gas cylinders are provided, the content of one gas cylinder is the sulfur hexafluoride gas, and the content of the other gas cylinder is an external gas.

3. The gas circulation apparatus for degradation of a sulfur hexafluoride gas according to claim 2, wherein the gas cylinders are connected to the relief valves, an ultrasonic atomizer is arranged between the two gas circuits, and the output end of the buffer gas chamber is communicated between one relief valve and one electromagnetic flowmeter.

4. A gas scrubbing mechanism, applied to the gas circulation apparatus for degradation of a sulfur hexafluoride gas according to claim 1, comprising:
a bearing part, comprising a bearing assembly and a gas supply assembly arranged on the bearing assembly;
inserting parts, comprising inserting assemblies arranged on the bearing assembly and closed assemblies arranged on the inserting assemblies;
fixing parts, comprising fixing assemblies arranged on the inserting assemblies and locking assemblies arranged on the gas supply assembly; and
cleaning parts, comprising water-collecting assemblies arranged on the bearing assembly, transmission assemblies arranged on the bearing assembly and cleaning assemblies arranged on the bearing assembly,
wherein the bearing assembly comprises a box body, an inserting cavity arranged on the box body, a limiting groove formed in the box body and supporting legs arranged on the box body.

5. The gas scrubbing mechanism according to claim 4, wherein the gas supply assembly comprises a distribution gas chamber arranged on the box body, a gas inlet pipe arranged on the distribution gas chamber and distribution gas pipes arranged on the distribution gas chamber,
several distribution gas pipes being provided, and the distribution gas pipes communicating with the inserting cavity.

6. The gas scrubbing mechanism according to claim 5, wherein the inserting assemblies comprise case bodies arranged on the inserting cavity, communicating pipes arranged on the case bodies and exhaust pipes arranged on the case bodies;
the closed assemblies comprise sealing rings arranged on the communicating pipes, connecting springs arranged on the case bodies, sealing pieces arranged on the connecting springs and ejection pieces arranged on the distribution gas pipes; and
the exhaust pipes are arranged at the top ends of the case bodies, the communicating pipes are matched with the distribution gas pipes, the sealing pieces are matched with the communicating pipes, and the sealing pieces are in contact with the ejection pieces.

7. The gas scrubbing mechanism according to claim 6, wherein the fixing assemblies comprise bosses arranged on the communicating pipes, fixed blocks arranged on the communicating pipes and movable blocks arranged on the communicating pipes;
the locking assemblies comprise connecting pieces arranged on the box body and jacking pieces arranged on the box body;
the connecting pieces comprise connecting cylinders arranged on the box body, partition plates arranged on the connecting cylinders, sliding grooves formed in the partition plates and wedge blocks arranged on the sliding grooves; and the jacking pieces comprise jacking springs arranged on the box body and jacking plates arranged on the jacking springs.

8. The gas scrubbing mechanism according to claim 6, wherein the water-collecting assemblies comprise water-collecting pieces arranged on the box body and water-collecting tanks arranged on the box body;
the transmission assemblies comprise accommodating grooves formed in the case bodies, driving teeth arranged in the accommodating grooves, transmission gears arranged on the box body, movable racks arranged on the box body and limiting tracks arranged on the box body; and
the driving teeth, the transmission gears and the movable racks are engaged mutually, and the sizes of the movable racks are matched with the sizes of the water-collecting pieces.

9. The gas scrubbing mechanism according to claim 8, wherein the cleaning assemblies comprise moving grooves formed in the water-collecting pieces and cleaning pieces arranged on the moving grooves; and
the water-collecting pieces comprise connecting plates arranged on the box body and ramps arranged on the connecting plates, the moving grooves are formed in surfaces of the connecting plates, the cleaning piece are in sliding connection with the moving grooves, and the cleaning pieces are matched with the ramps.

10. The gas scrubbing mechanism according to claim 9, wherein several inserting parts, fixing parts and cleaning parts are provided, the cleaning parts are arranged on a lower surface of the box body, and the water-collecting tanks are adapted to the positions of the joints of the distribution gas pipes and the communicating pipes.
